(19) United States
(12) Patent Application Publication
(10) Pub. No.: US 2002/0113162 A1
(43) Pub. Date: Aug. 22, 2002

(54) Indicator for dispensing rolled goods

(76) Inventors: James C. Fournier, Racine, WI (US); Robert Alan Stone, Bristol (GB)

Correspondence Address: Lisa M. Soltis, Illinois Tool Works Inc., 3600 West Lake Avenue, Glenview, IL, 60025, US

(21) Appl. No.: 09/788,088

(22) Filed: Feb. 16, 2001

(51) Int. Cl. B65H 26/06; G08B 5/02

(52) U.S. Cl. 242/563.2; 116/282; 33/733

(57) ABSTRACT

The present invention provides an indicator and indicator cartridge that shows the amount of material on a roll. The roll preferably has at least one toothed sprocket, the indicator, and includes a rotatable rod which is rotated through engagement with the rotating roll. At one end of the rod, a pinion gear is fixed to engage the toothed sprocket. An indicator member is slidingly configured to engage the rod such that the rotation is at least partially converted to linear motion of the indicator member. The rod and the indicator member are preferably threaded. A reference point is included for showing the linear displacement of the indicator member relative to the rod.

### BACKGROUND OF THE INVENTION

This invention relates to an indicator for dispensing or acquiring of goods as would be suitable for use with thermal transfer ribbons. More specifically, the present invention relates to an indicator that shows the amount of material that has been acquired or dispensed from a cartridge.

In the printing industry, printers use a removable cartridge that contains a ribbon coated with ink (e.g., dry ink). During printing operations, the ribbon is advanced as it is being used until the end of the ribbon is reached. Typically, there is no indication as to how much of the ribbon is used, so that the operator has no idea how much usable ribbon remains in the cartridge before starting the job. An operator could estimate the usable length of ribbon from the amount of material on the supply and take-up rolls. However, it would be inefficient to spend the time to remove each cartridge to make an inaccurate guess at how much usable ribbon remains.

Jobs are frequently printed using several colors. For example, a color printing operation that uses the thermal transfer process may use four or more colors selected from over eighty available colors. Each color is printed individually using a color ribbon contained in its own cartridge, usually with no indicator of how much of the ribbon has been used. If a single cartridge runs out of ribbon during printing, the printed image, which may have involved several color printing operations, must be scrapped.

Indicators are used on a printer or an integrated computer in an attempt to track the amount of remaining usable ribbon. However, the indicator can only track ribbon usage while that cartridge is installed in that particular printer. If a partially used cartridge is installed from another printer, there is no marker that tells how much of the ribbon has been used. This is inconvenient in an industry where the required colors will vary from job to job and the color cartridges are frequently exchanged. Also, if a printer with this feature is replaced, the function is lost unless the replacement equipment has the same feature.

Another system for dealing with this problem has been addressed in U.S. Pat. No. 5,807,001 to Hammill et al. The cartridge has marks on the hub of the supply spool to indicate the amount of ribbon on the spool, and an opening to provide visibility of the marks. An operator can look through the opening, and make an estimate of the amount of material left compared to the marks on the hub. This method provides a more accurate estimate of the amount of remaining ribbon than simply “eye balling” the supply and take-up spools, but it is still a relatively crude measurement. Since the inked material is thin (i.e., a thermal transfer ribbon is typically only 6 microns thick), the indicator lines have to be very close together, making them difficult to read. Also, using this technique, if, for example, there is air entrained between the layers or a wrinkle in the material that makes the thickness of material on the roll appear to be larger than is typical, additional inaccuracies will be introduced.

It is an object of this invention to provide an improved and more accurate apparatus for indicating the amount of usable material remaining on a supply roll or for indicating the amount of used material that has been dispensed from the supply roll.

It is another object of this invention to provide an improved indicator for a cartridge that is self-contained within the cartridge.

It is still another object of this invention to provide an improved indicator for a cartridge that maintains the indicator status of the amount of material acquired or dispensed from the roll when it is removed from the associated equipment.

It is yet another object of this invention to provide an improved indicator for the amount of material remaining on a roll that operates independently particular equipment with which it is used.

### SUMMARY OF THE INVENTION

These and other objects are met or exceeded by the present invention which features a self-contained cartridge that indicates how much material remains or has been dispensed from a roll. The indicator is very accurate and holds its place when moved to another device.

More specifically, the present invention provides an indicator that shows the amount of material on a roll. The roll has one or more toothed sprockets, and the present indicator includes a rod that rotates on its longitudinal axis. A pinion gear is fixed to one end of the rod so that it rotates with the rod on its longitudinal axis by engaging at least one of the teeth of the roll. An indicator is slidingly configured to engage the rod such that the rotational motion of the longitudinal axis is at least partially converted to a linear motion. An indicator device is constructed and arranged for showing the linear movement of the indicator.

A cartridge is also disclosed that utilizes the indicator of the present invention. Preferably, both the rod and the indicator are threaded and are mounted to the cartridge wall. Also, the linear movement of the threaded indicator is visible on the outside of the cartridge. The indicator cartridge could be used in several industries where material is transferred by being removed from or added to a roll.

The present invention provides a self-contained indicator system that operates independently of the particular roll-consuming equipment with which it is used. Indicator readings will not change when equipment is replaced, repaired or obtained as new, regardless of the features that are included. Because the present indicator system is self-contained, notice of how much material remains is not lost merely because the cartridge is moved to a different printer. No inputs or outputs are needed; the indicator is not read or sensed by the printer. As a result of this independence, the indicator works continuously, even when the roll is manually turned outside of the printer.

Further, the present system is very accurate. The system effectively counts the number of revolutions of the roll with the toothed sprocket and pinion gear, rather than measure the thickness of material on the roll, providing a more accurate measurement. Also, when used to measure the material to be dispensed, the indicator measures smaller quantities as the end of the roll approaches, because the amount of material dispensed per revolution becomes smaller. The accuracy can be adjusted by changing the sprocket combination, or the pitch of the threaded rod, or even by providing finer graduations on a scale adjacent the indicator.

### DETAILED DESCRIPTION OF THE DRAWINGS

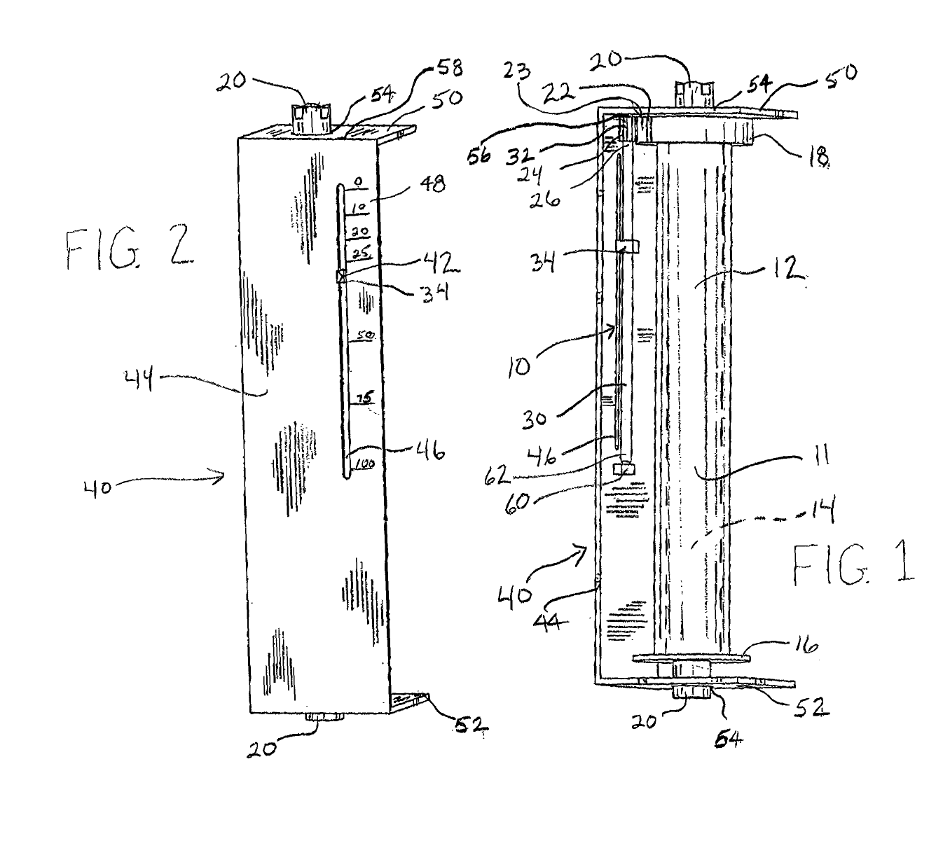

FIG. 1 is a front perspective view of the indicator and cartridge; and

FIG. 2 is a rear perspective view of the indicator and cartridge of FIG. 1.

### DETAILED DESCRIPTION OF THE INVENTION

Referring now to FIGS. 1 and 2, an indicator, is shown and is generally designated 10. The present indicator displays the amount of material 11 acquired or dispensed from a roll 12. Although this invention will be discussed in terms of a printing cartridge 10, it is to be understood that the apparatus is suitable for use in other contexts as well. Other industries store and dispense materials such as paper, fabrics or various ribbons by the roll 12. The present indicator may be useful in a number of these applications. This indicator is also suitable for use with either the supply roll 12 or the take-up roll (not shown), and the invention is intended to apply to either, even though the discussion is directed to dispensing of the material 11.

The roll 12 contains any web-like material 11 that is suitably dispensed, such as paper, fabrics, ribbons, woven adhesives, plastic films and sheeting and the like. A suitable drive mechanism is used to get the material off the roll 12, and includes a cylindrical core 14 (shown hidden) having an end hub 16, 18 at either end. The sides of the material 11 are contained within the end hubs 16, 18, so that the distance between the hubs defines the maximum width of the rolled material. An axle 20, generally concentric with the core 14 and hubs 16, allows the roll 14 to turn as the material is withdrawn. The axle 20 is preferably a continuous piece inside the core. In another option, the axle 20 consists of two collinear portions secured to a corresponding hub 16, 18, that perform the function of a single axle, allowing the roll 14 to rotate.

The end hub 18 has at least one sprocket 22. The sprocket 22 may be an integral part of the end hub 18, or it may be attached to the hub after construction of the separate parts, by chemical adhesives, ultrasonic welding or similar known techniques. The sprocket 22 is made from any substance (metal, plastic, etc.) with sufficient strength to rotatably engage a pinion gear 24, without becoming broken, fractured, chipped or misshapen. Most preferably, there is only one sprocket 22 on the end hub 18. The sprocket 22 is shaped to matingly engage the pinion gear 24 on a first end 26 of a threaded rod 30.

The pinion gear 24 is fixed to the first end 26 of the threaded rod 30 in a manner that they rotate together about the longitudinal axis of the threaded rod. Longitudinal axes of the pinion gear 24 and the threaded rod 30 are generally collinear. As with the sprocket 22 discussed above, the construction material selected for the pinion gear 24 should have sufficient strength to withstand rotatable engagement with the sprocket 22. Preferably, the pinion gear 24 is separately constructed from the threaded rod 30, but it is also contemplated that they be made of unitary construction.

One or more teeth 32 are located on the pinion gear 24 that matingly engage with the teeth 23 of the sprocket 22 of the roll 12. The ratio of the number of sprocket teeth 23 to the number of teeth 32 will determine how many times the threaded rod 30 will rotate as the roll 12 rotates to dispense the material. Preferably, the number of teeth 32 exceeds the number of sprocket teeth 23 to maintain a relatively short length of travel of an indicator 34 engaged on the rod 30. While the engagement of the toothed sprocket 22 and pinion 24 is the mechanism for transmitting of rotation from the roll 12 to the rod 30, it will be appreciated that other known drive mechanisms are contemplated, including but not limited to function wheels made of resilient material or wheels having textured surfaces for transmitting rotation.

The number of threads per inch on the threaded rod 30 and the ratio of the number of teeth 23 on the roll 12 to the number of teeth 32 determine the length of the threaded rod 30 needed to accommodate the length of travel of the threaded indicator 34. If the roll 12 rotates 320 times to empty it, then the indicator 34 travels 10 inches down the threaded rod 30 if the rod has 32 threads per inch. When contained in a cartridge 40, as is preferred, there is limited space through which the indicator 34 can travel. A preferred range of from about 2 to about 20 teeth 32 per sprocket tooth 23 keeps the travel distance that is utilized by the threaded indicator 34 small enough to fit comfortably in the cartridge 40. Most preferably, from about 4 to about 10 teeth 32 are located on the pinion gear 24, and a single tooth 23 is used on the end hub 18 of the roll 12. Thread pitch of the threaded rod 30 will determine how far the indicator 34 will travel for each rotation of the threaded rod. Fine threads, such as 32 threads per inch, are preferred for the threaded rod 30; however, thread pitch is variable depending on the application.

Rotational motion of the longitudinal axis of the threaded rod 30 is at least partially converted to a linear motion through movement of the threaded indicator 34, which is configured to engage the threaded rod 30. While in the preferred embodiment the rod 30 and the indicator 34 are threaded, other configurations are contemplated by which the indicator moves linearly along the rod in response to rotation of the rod. As long as the indicator 34 is not permitted to rotate with the rod 30, rotation of the rod will cause the indicator 34 to move linearly along the length of the rod, translating at least a portion of the rotational motion in to a linear motion. Many techniques are suitable for preventing rotation of the threaded indicator 34. For example, a projection 42 on the indicator 34 preferably rides in a groove on the cartridge wall 44, or the indicator could slidably engage a stationary, smooth rod (not shown) to prevent rotation. Most preferably, the indicator has a projection 42 that reciprocally slides in a slot 46, allowing the projection to move in a direction parallel to the slot, but preventing motion perpendicular to the slot. The slot 46 is a special type of the groove that extends through the entire thickness of the wall 44.

When the indicator 34 is contained within the cartridge 40, a scale 48 or other mechanism is provided for referencing the linear movement of the threaded indicator 34, since it would be inconvenient and time-consuming for an operator to have to remove each cartridge to determine the position of the indicator. In the preferred embodiment, the scale 48 reflects the number of meters of ribbon or material 11 on the roll 12. A slot 46 or window, either covered with transparent material or left open, permits the operator to reference the indicator 34 without removing the cartridge 40. Other examples include a projection 42 with needle like portion wraps around the edge of the cartridge wall 44, or a row of light-emitting diodes, which sequentially illuminate as a contact inside the cartridge is connected by passage of the indicator 34. In the most preferred embodiment, the slot 46 and the projection 42 serve a dual purpose. They not only prevent rotation of the threaded indicator 34 relative to the rod 30 but the projection 42 is visible through slot 46 from the outside of the cartridge 40 to provide the information to the operator as to the length of material 11 remaining on the roll 12. Visibility of the projection 42 is increased by optionally making it a contrasting color to the cartridge wall 44.

The cartridge 40 provides a covering to the material roll 12 to make it easier to handle, install and remove from the printer. Particular in the printing industry, the roll of inked ribbon (e.g., thermal transfer ribbon) can be difficult to handle. The cartridge wall 44 provides a surface that is convenient to hold onto without the risk of damaging the sensitive ribbon. Also, it optionally serves to aid in alignment of the roll during installation in the printer. Either the supply roll 12 or the take-up roll or both are optionally included in the cartridge 40. The cartridge 40 need not totally enclose the roll, and preferably includes a top wall 50, and a bottom wall 52, joined to the side wall 44 to form a general “U” shape. The walls 44, 50 and 52 are preferably integrally forward, however other fastening techniques are contemplated, including: chemical adhesives and ultrasonic welding. The axle 20 passes through openings 54 in the top wall 50 and the bottom wall 54 for engagement with the printer.

When the indicator 10 is disposed within the cartridge, at least one bearing block 60 is fixed to the cartridge wall 44 to support a second end 62 of the threaded rod 30. The second end 62 of the threaded rod 30 is rotatably received in the bearing block 60. At the end of pinion gear of the rod 30, a stub shaft 56 projects through and rotatably engages an opening 58 in the top wall 50.

While a particular embodiment of the present indicator and indicator cartridge has been shown and described, it will be appreciated by those skilled in the art that changes and modifications may be made thereto without departing from the invention in its broader aspects and as set forth in the following claims.

What is claimed is:

1. An indicator for displaying the amount of material on a rotating roll, comprising:
a rod configured for being rotated by rotation of the roll;
an indicator member engaged on said rod for linear displacement on said rod upon rotation of said rod; and
a reference point for determining the amount of linear displacement of said indicator member on said rod.

2. The indicator of claim 1 further including a cartridge configured for rotatably receiving the roll and said rod.

3. The indicator of claim 2 wherein said cartridge includes a wall upon which said reference point is located.

4. The indicator of claim 1, wherein said roll has a toothed sprocket, and said rod includes a toothed pinion configured for engaging said sprocket so that rotation of said roll causes rotation of said rod.

5. The indicator of claim 4 wherein the number of teeth on the sprocket exceeds the number of teeth on said pinion.

6. The indicator of claim 1 wherein said rod is threaded and said indicator member threadably engages said rod so that rotation of said rod causes linear displacement of said indicator member.

7. The indicator of claim 6, wherein said rod has at least 32 threads per inch.

8. The indicator of claim 1, further including a cartridge configured for rotatably receiving the roll and said rod, said cartridge includes a wall defining a slot in which said projection reciprocates.

9. A cartridge that indicates the amount of material on a roll mounted within said cartridge, comprising:
a cartridge wall configured to rotatably support said roll;
a rod configured for being rotated by rotation of said roll;
an indicator member engaged on said rod for linear displacement on said rod upon rotation of said rod; and
a reference point for determining the amount of linear displacement of said indicator member on said rod.

10. The cartridge of claim 9, wherein said roll has a toothed sprocket, and said rod includes a toothed pinion configured for engaging said sprocket so that rotation of said roll causes rotation of said rod.

11. The cartridge of claim 10 wherein the number of teeth on the sprocket exceeds the number of teeth on said pinion.

12. The cartridge of claim 9 wherein said rod is threaded and said indicator member threadably engages said rod so that rotation of said rod causes linear displacement of said indicator member.

13. The cartridge of claim 10, wherein said rod has at least 32 threads per inch.

14. The cartridge of claim 9, wherein said indicator member has a projection for indicating the position of said indicator member relative to said rod.

15. The cartridge of claim 14, wherein said cartridge includes a wall defining a slot in which said projection reciprocates.

16. The cartridge of claim 9 wherein said reference point is located on said cartridge wall.
